(19) United States
(12) Patent Application Publication
(10) Pub. No.: US 2007/0223433 A1
(43) Pub. Date: Sep. 27, 2007

(54) Location managing apparatus and location managing method

(75) Inventor: Naotoshi Watanabe, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/475,892

(22) Filed: Jun. 28, 2006

(30) Foreign Application Priority Data
Mar. 27, 2006 (JP) 2006-085846

(51) Int. Cl. H04Q 7/24

(52) U.S. Cl. 370/338

(57) ABSTRACT

A storing unit stores information on rejection of a request for connection to a desired network made by a mobile network, when congestion has occurred on a communication path of the desired network; a searching unit searches in the storing unit, when the congestion is resolved, to retrieve a mobile station of which the request has been rejected; and a notifying unit notifies retrieved mobile station that the desired network is available.

### CROSS-REFERENCE TO RELATED APPLICATIONS

This application is based upon and claims the benefit of priority from the prior Japanese Patent Application No. 2006-085846, filed on Mar. 27, 2006, the entire contents of which are incorporated herein by reference.

### BACKGROUND OF THE INVENTION

1. Field of the Invention

The present invention relates to a technology for managing location of a mobile station.

2. Description of the Related Art

Various networks have been built as wireless access networks, and different kinds of networks, including old and new, depending on types of access, such as a general packet radio service (GPRS) and a wireless local area network (WLAN), depending on types of provided services, such as quality of service (QoS) and best effort, or according to a rate are in use at the same time.

To support these different types of communication services and to provide economical mobile communication over these access networks, connection of the networks using an IP protocol and location management of mobile stations using a Mobile Internet protocol (IP) have been proposed. With the progress of the wireless access networks, service areas of plural access networks are overlapped. A user of a mobile station can select an access network from plural networks, and can use different access networks at the same time. The user can switch among access networks to which the mobile station is connected based on use conditions of services, considering various conditions such as a charge condition (for example, Yuji Fukunaga, “Feature: Detailed Explanation on Mobile IP Technology”, [on line], Sep. 21, 2002, @IT, [retrieved on Mar. 10, 2006], the Internet <URL: http://www.atmarkit.co.jp/fnetwork/tokusyuu/15mobileip/mip01.html>).

When Mobile IP is used, a location managing node is a home agent (HA). The mobile node (MN) registers a home address (HoA) assigned fixedly by its home network and a care-of address (CoA) temporarily used in a visited network correlated to each other. According to a technique disclosed in Japanese Patent Laid-Open No. 2003-204330, the HA provided on the access network side manages a mobile station based on information (the home address and the care-of address) stored in a binding cache, when a location of the mobile station is registered, and when switching is requested due to a change of location of the mobile station. According to the technique, a processing load on HA can be reduced by controlling intervals for re-registration of an entry with respect to a valid entry that has already been registered.

A packet transmitted to HoA of MN by a communication correspondent node CN that is a counterpart of a communication is received by HA, and HA encapsulates and tunnels packet to CoA of MN. Thus, MN can communicate with CN even when MN moves to other network than the MN's home network (i.e. visited network). Although both IPv4 and IPv6 are defined as the Mobile IP, the basic operation is common. However, in IPv4, an external agent that is a foreign agent (FA) that terminates the tunnel in stead of MN is defined in a network at the mobile destination.

FIG. 9A is a schematic for illustrating a conventional location management control. The flow of operation for connecting with a single access network is included in the access network switching operation. The location managing node HA executes a communication service to a mobile node MN1 that is connected to an access networks AN#a and AN#b. The MN1 has HoA_1 as a home address, and communicates with a communication correspondent node CN#1 through AN#a using a care-of address CoA_a. At this time, HA retains information on correlation between HoA_1 and CoA_a, recorded as the binding cache, and tunnel transfer is executed in a section from HA through AN#a to MN1 referring to the information on the correlation.

The access networks AN#a and AN#b are wireless access networks. When MN1 discovers the different access network AN#b as the MN1 changes a location and a condition of wireless communication changes, (1) MN1 checks a wireless quality of AN#b, and (2) requests switching from AN#a to AN#b based on a service that the user of MN1 desires. The switching is achieved by registering CoA_b captured/used in AN#b into HA, deleting a binding cache entry of CoA_a when the registration has been successfully completed, and switching the tunnel transfer to AN#b.

However, in the above conventional technique, it is difficult to reduce time required for switching communication paths (communication path setting time) at the location managing node HA. When MN1 requests the switching to AN#b based on wireless conditions such as a radio signal strength, a communication quality is expected to be maintained. However, when the line between AN#b and HA is congested (traffic is crowded), the communication quality can not be maintained. Therefore, when HA has received a switching request to switch to AN#b, this switching is permitted when the HA/AN#b communication path is not congested and the communication quality (e.g. bandwidth) desired by MN1 can be obtained in the communication path. Therefore, MN1 sends the switching request together with information on the desired communication quality (for example, Japanese Patent Laid-Open No. 2005-250096).

FIG. 9B is a sequence diagram illustrating a flow of the conventional location management control. FIG. 9B is depicted corresponding to the configuration shown in FIG. 9A. As shown in FIG. 9A, (3) when the HA/AN#b communication path is congested, during this congested period Tx, (2) even when a switching request has been made, (4) HA notifies MN1 of a switching rejection (of a failure in registering CoA_b using a location registration response message). To avoid waste of the wireless resources of the wireless access network AN#b, MN1 that has received the switching rejection waits until a general congestion duration T1 (for example, 1 second) elapses using an internal timer. Then, (5) MN1 transmits a re-request (a request requesting the switching again) as a location registration message of CoA_b.

In the example shown in FIG. 9B, (4) the congestion has just been resolved when MN1 receives the switching rejection notice, and MN1 is kept waiting for the time equal to the general congestion duration T1 before connecting to AN#b. The congestion duration T1 may not be fixed term and may be a variable term that is random or based on the number of re-tries. However, the average value and the initial value are set using the above congestion duration T1. Therefore, drastic reduction can not be done because a time period in seconds is necessary to complete the setting of the communication path to a desired access network. If the re-try cycle is shortened, the communication path setting time can be reduced. However, the resources of the wireless access network are consumed.

As described above, according to the conventional technique, when the access network that is the destination of the requested switching is congested, quick switching can not be achieved even if the mobile station MN has requested switching. Not only for such switching of access networks but also for connection to a new access network, quick setting and connection of communication paths are demanded.

### SUMMARY OF THE INVENTION

It is an object of the present invention to at least solve the above problems in the conventional technologies.

An apparatus according to one aspect of the present invention performs location management for a mobile station connected thereto through a plurality of networks, and determines whether to permit or reject a request for connection to a desired network made by the mobile station. The apparatus includes a storing unit configured to store information on rejection of the request for the connection when congestion has occurred on a communication path of the desired network; a searching unit configured to search in the recording unit, when the congestion is resolved, to retrieve a mobile station of which the request has been rejected; and a notifying unit configured to notify retrieved mobile station that the desired network is available.

A method according to another aspect of the present invention is of performing location management for a mobile station connected through a plurality of networks in which whether to permit or reject a request for connection to a desired network made by the mobile station is determined. The method includes storing information on rejection of the request for the connection when congestion has occurred on a communication path of the desired network; retrieving, when the congestion is resolved, a mobile station of which the request has been rejected, from the information; and notifying retrieved mobile station that the desired network is available.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a location managing apparatus according to a first embodiment of the present invention;

FIG. 2 is a flowchart of a location registration process by the location managing apparatus;

FIG. 3 is a schematic for illustrating a binding cache table;

FIG. 4 is a flowchart of a location registration request by the location managing apparatus;

FIG. 5 is a sequence diagram for illustrating a flow of a location management control according to the first embodiment;

FIG. 6 is a flowchart of a location registration process by a location managing apparatus according to a second embodiment of the present invention;

FIG. 7 is a schematic of a location managing apparatus according to a third embodiment of the present invention;

FIG. 8A is a flowchart of a location registration process by a location managing apparatus according to the third embodiment;

FIG. 8B is a sequence diagram for illustrating a flow of a location management control according to the third embodiment;

FIG. 9A is a schematic for illustrating a conventional location management control; and

FIG. 9B is a sequence diagram for illustrating a flow of the conventional location management control.

### DETAILED DESCRIPTION OF THE PREFERRED EMBODIMENTS

Exemplary embodiments according to the present invention will be explained in detail with reference to the accompanying drawings. In the explanation, Mobile IPv4 and Mobile IPv6 will be described without especially distinguishing therebetween except for the external agent (FA) described in a third embodiment.

The embodiments of the present invention have the following characteristic:

1. As soon as a congestion state at a destination to which a mobile station has requested to connect is resolved, the location managing apparatus notifies the mobile station that switching of access networks to the destination is possible.

2. When the location managing apparatus has rejected registration due to insufficient bandwidth resources of an access network at the requested destination, the location managing apparatus stores the condition of the rejection, and as soon as enough resources get available, notifies the mobile station accordingly to provide an opportunity to switch access networks to the requested destination.

3. The notice to the mobile station is incorporated in an existing location control message (adding an availability notice flag).

4. When the location control is based on Mobile IP, the notice is piggybacked to a Mobile IP control message.

5. For switching of existing communication paths, whether the resources are secured is judged based on actually measured values retained by the location managing apparatus.

6. A quality request (for example, QoS declaration) from the mobile station, and extraction/analysis thereof by the location managing apparatus are not required to reduce response time to the mobile station.

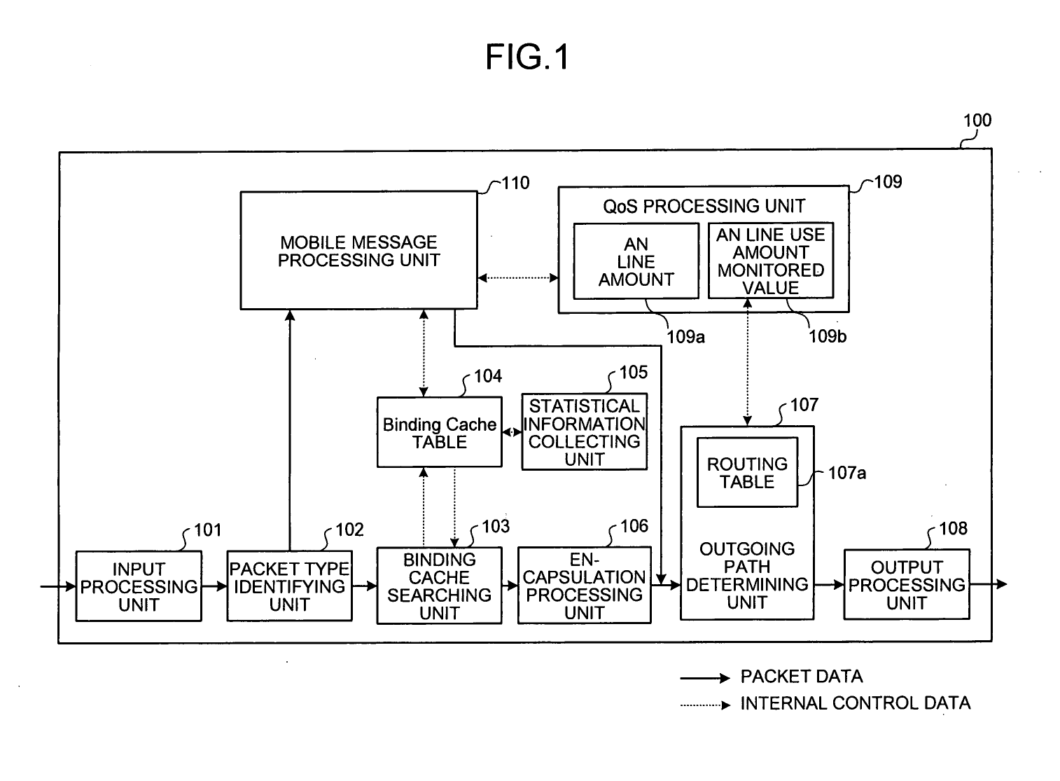

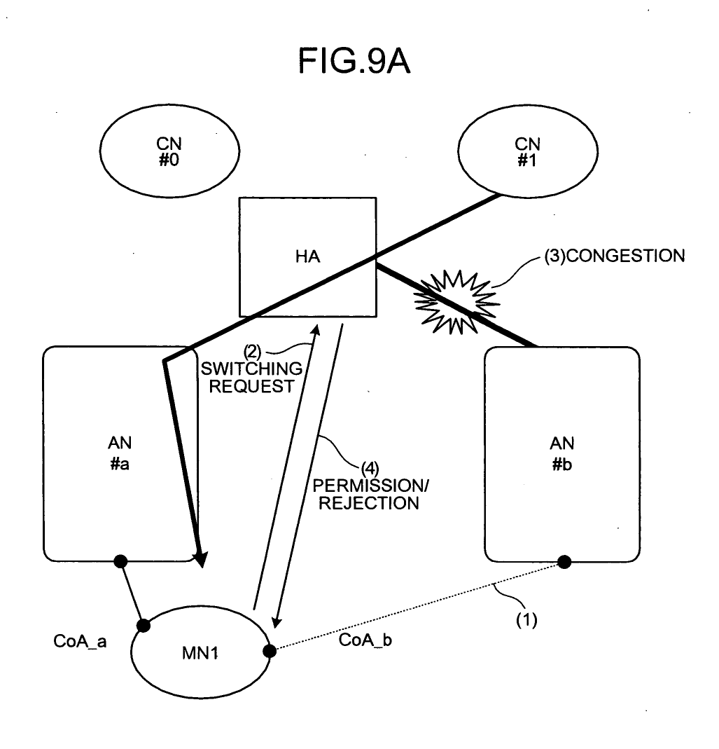

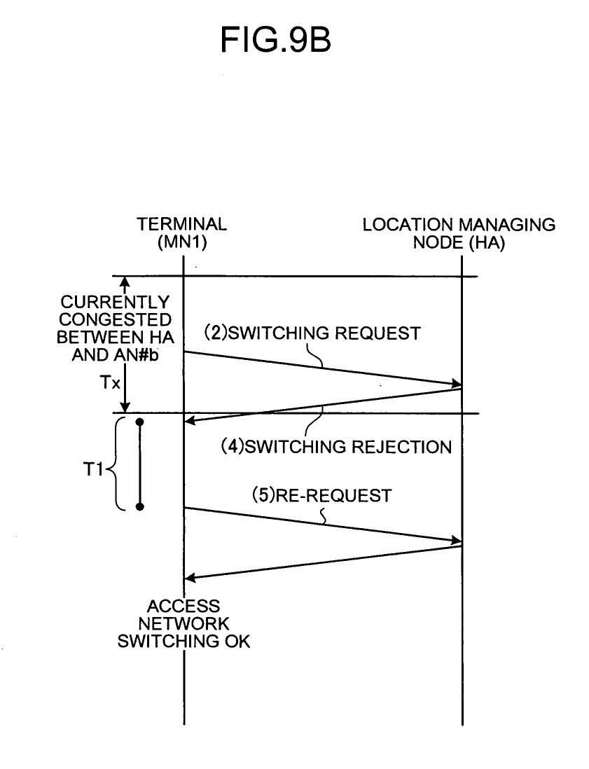

FIG. 1 is a schematic of a location managing apparatus according to a first embodiment of the present invention. The entire configuration of the location management is similar to that shown in FIG. 9A. A location managing apparatus (HA) 100 that is a location managing node includes an input processing unit 101, a packet type identifying unit 102, a BC searching unit 103, a BC table 104, a statistical information collecting unit 105 that collects statistical information by the BC table 104, an encapsulation processing unit 106, an output path determining unit 107 having a routing table 107a, an output processing unit 108, a QoS processing unit 109 having a retaining unit for an AN line amount 109a and an AN line use amount monitored value 109b, and a mobile message processing unit 110. The QoS processing unit 109 has a function as a quality assurance processing unit that judges whether the quality of a communication path in an access network can be maintained before and after switching.

The input processing unit 101 receives a packet from a network connected thereto. The packet type identifying unit 102 identifies the type of the received packet. When this received packet is not a location managing protocol message, the packet is sent to the BC searching unit 103. The BC searching unit 103 searches the BC table 104 using the addressee address of the packet as a key. When a valid entry is present in the BC table 104, the unit 103 notifies the encapsulating unit 106 of CoA in the entry. The encapsulating unit 106 executes IP encapsulation of the received packet using CoA as the addressee. The output path determining unit 107 determines an output path by the ordinary IP routing based on the addressee address (CoA in the above example) of the packet inputted from the encapsulating unit 106, and transmits the received packet that has been encapsulated from the output processing unit 108 corresponding to the output path to a connected network.

When no valid entry is present in the BC table 104, the received packet is transmitted through the encapsulating unit 106 without executing the encapsulation, and the output path determining unit 107 executes routing to the received packet as it is.

The output path determining unit 107 has a function of monitoring the traffic amount for each access network (line) to be connected with and notifies the QoS processing unit 109 of the monitoring result. The QoS processing unit 109 retains the AN line use amount monitored value 109b for each access line as well as the predetermined AN line amount (e.g. capacity) 109a. Using these values, the QoS processing unit 109 executes acceptance control (i.e. admission control) of connection/switching request to the access network.

A message for the location management control is identified by the packet type identifying unit 102 in the latter stage of the input processing unit 101. When the packet type identifying unit 102 has received the location management control message, the packet type identifying unit 102 delivers the received data to the mobile message processing unit 110. The mobile message processing unit 110 further identifies the type of the message and executes a process according to the message.

The mobile message processing unit 110 receives the location registration message, extracts information of quality request such as a requested bandwidth, and executes the acceptance judgment of whether the requested bandwidth can be accommodated in the line of the access network corresponding to CoA for which registration is requested in the location registration message. The process of this acceptance judgment is executed using information on the access line from the QoS processing unit 109. When the requested bandwidth can not be accommodated, a location registration response message to which the failure of the registration is coded is created to be transmitted to the mobile station MN. When the requested bandwidth can be accommodated, the requested CoA is registered in the BC table 104. A location registration response message to which the success of the registration is coded is created to be transmitted to the mobile station MN.

When the received location registration message is a switching request of access networks, the entry of CoA having the same home address for which communication is currently executed is deleted from the BC table 104. When no switching is specified, no process for switching is executed because the message is for updating the existing connection. The above specification/coding of new connection/switching or success of registration/failure of registration are represented by flags or codes in each message.

In addition to the above processes based on the reception of the location registration message, the mobile message processing unit 110 executes an entry management control of the BC table 104.

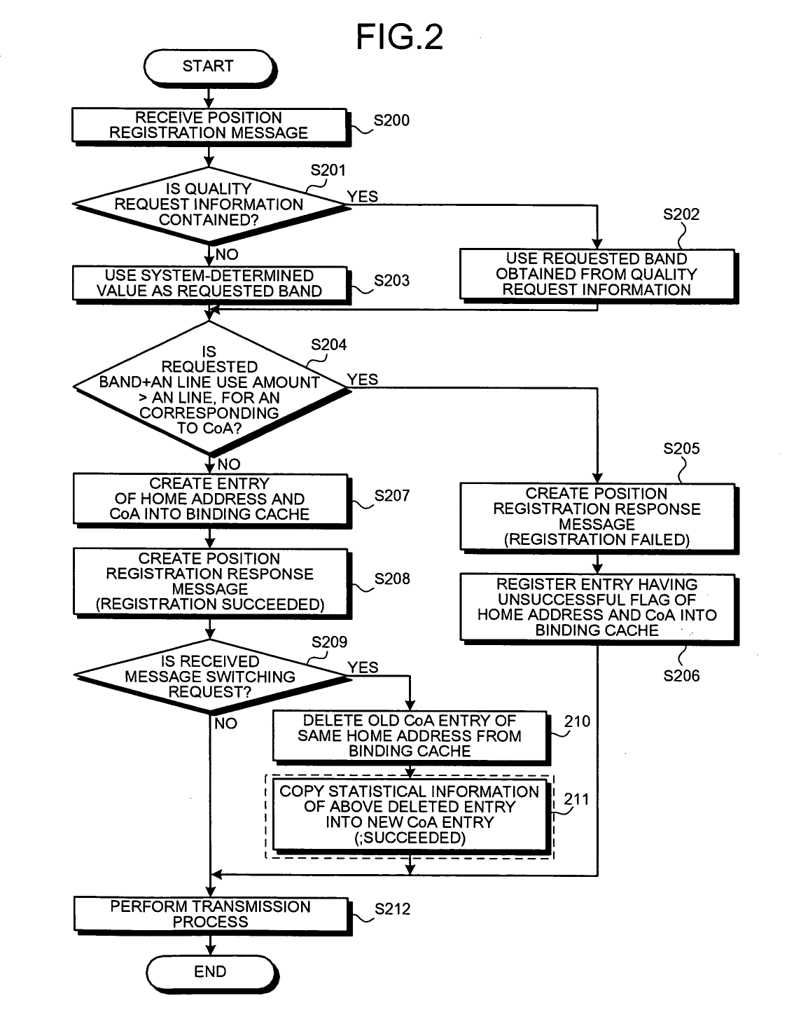

FIG. 2 is a flowchart of a location registration process by the location managing apparatus (e.g. HA). When the mobile message processing unit 110 of the location managing apparatus 100 has received a location registration message from the mobile station MN (step S200), the mobile message processing unit 110 checks whether this location registration message contains quality request information such as a requested bandwidth (step S201). This location registration message is a switching request of the access network AN by the mobile station MN. When the quality request information is contained (step S201: YES), the requested bandwidth extracted from the quality request information is used in the following acceptance judgment (step S202). When the quality request information is not contained (step S201: NO), a value determined by the system is used for the requested bandwidth (step S203).

Whether the requested bandwidth can be accommodated in the access network AN corresponding to CoA of which registration is requested in the location registration message is judged (steps S204). This acceptance judgment process judges whether congestion has occurred referring information on the access line of the QoS processing unit 109 and using, for example, the following Equation 1.
requested bandwidth+AN line use amount>AN line (1)

When it is judged that the requested bandwidth can not be accommodated (step S204: YES), a location registration response message in which the failure of the registration is coded is created (step S205), registration of an entry indicating the failure of the registration is executed by recording home address and CoA of the requesting mobile station MN with setting a failure flag in the BC table 104 (step S206), the message is transmitted to the mobile station MN (step S212), and the above process is ended. The failure of the registration is notified to the mobile station MN1 as a connection rejection to the access network AN#b.

When it is judged that the requested bandwidth can be accommodated (step S204: NO), an entry of the requested information is created in home address and CoA of the BC table 104 (step S207), a location registration response message in which the success of the registration is coded is created (step S208), a process for transmission to the mobile station MN is executed (step S212), and the above process is ended.

It is judged whether the received message (location registration message) is a switching request of the access network AN (step S209). When the message is a switching request (step S209: YES), the entry of CoA having the same home address for which communication is currently executed is deleted from the BC table 104 (step S210), and the transmission at step S212 is executed. On the other hand, when the message is not a switching request (step S209: NO), because the message is for updating the existing connection after the process at step S208, the transmission at step S212 is executed and the above process is ended.

The transmission process at step S212 corresponds to the process executed at the units from the mobile message processing unit 110 through the output path determining unit 107 to the output processing unit 108. The above specification/coding of new connection/switching or success of registration/failure of registration are represented by flags or codes in each message.

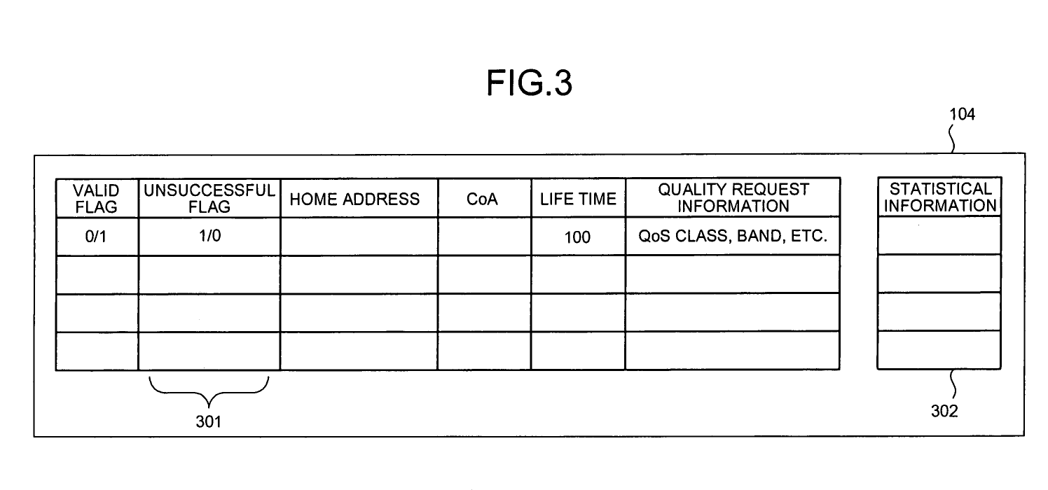

FIG. 3 illustrates contents of the BC table. The BC table 104 functions as a recording unit that stores information in a form of a table. Each entry in this table has a valid flag, a failure flag, home address, CoA, life time, quality request information, statistical information, etc. Although the value of life time can also be registered based on the location registration message of the mobile station MN, this value can be set according to the operation policy on the HA 100 side. In the example shown, life time is set to 100. When life time has expired to be 0, HA 100 notifies the mobile station MN of the expiration using the location registration request message, requests re-registration of CoA, and updates the entries. In the BC table 104, in addition to the above existing configuration, a flag area 301 of the above an unsuccessful flag is provided by adding the area 301 to the table 104. In statistical information 302, information collected by the statistical information collecting unit 105 is registered. This statistical information 302 stores a fixed system-determined value when the quality request information is not contained in the location registration message.

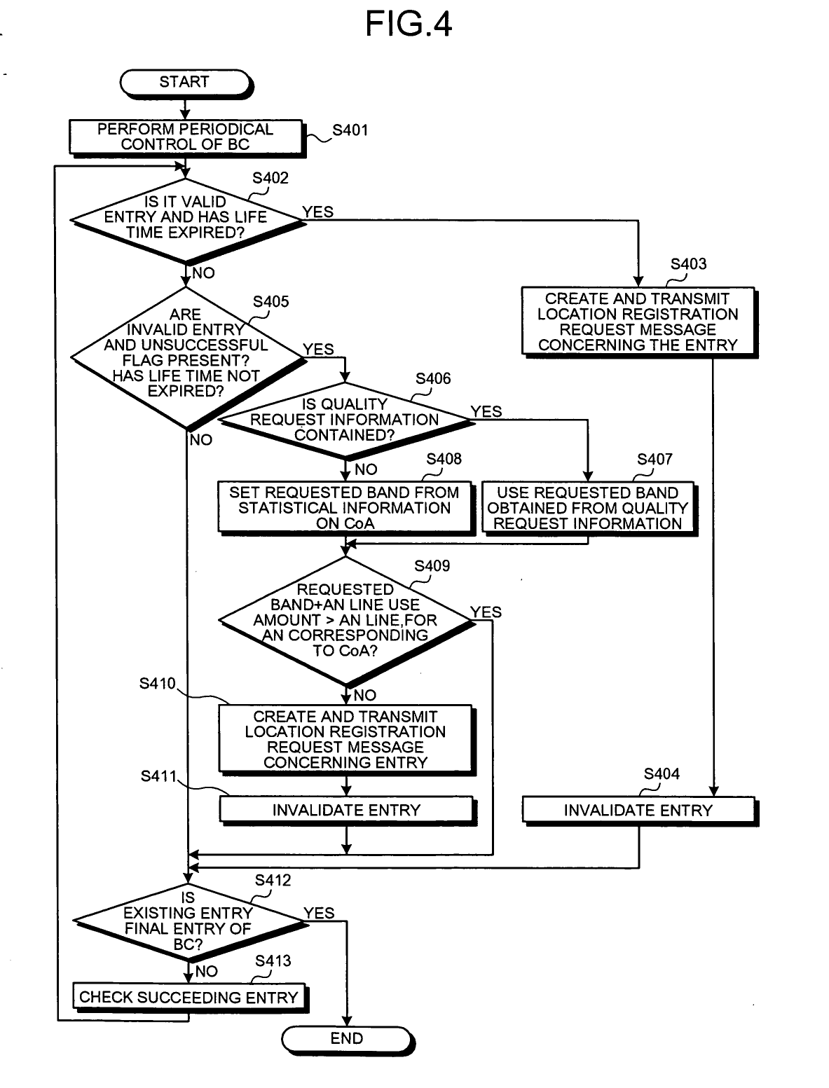

FIG. 4 is a flowchart of a process of the location registration request by the mobile managing apparatus (HA). Processes at steps S405 to S411 are the processes added in the embodiment of the present invention, and other processes are the existing processes.

The BC searching unit 103 of the location managing apparatus 100 periodically processes the BC table 104 (step S401). In this periodical process, the BC table 104 is checked by a periodic trigger using a timer.

When the process is triggered, each entry in the BC table 104 is checked one by one. First the target entry is checked whether it is a entry having an expired life time (step S402). As a result of the checking, when a valid entry having an expired life time are present (step S402: YES), a location registration request message for this entry is created and is transmitted to the mobile station MN (step S403). Then, this entry is invalidated (step S404), and the process is moved to step S412.

When the target entry is not a valid entry having an expired life time (step S402: NO), the processes at steps S405 to S411 are executed. At step S405, it is judged whether this entry is the candidate entry for access network switching/connecting. The candidate entry has an invalid flag, a failure flag, and a life time that is not expired. When this entry is not the above candidate (step S405: NO), the process is moved to step S412. When this entry is the above candidate (step S405: YES), it is judged whether this entry contains the quality request information (step S406). When this entry contains the quality request information (step S406: YES), a requested bandwidth registered in the quality request information of the BC table 104 (see FIG. 3) is used (step S407), the process is moved to step S409. When this entry does not contain the quality request information (step S406: NO), the requested bandwidth is set from the statistical information 302 concerning CoA (step S408) and the process is moved to step S409.

At step S409, it is judged whether congestion has occurred in the access network AN corresponding to CoA. In this judging process, information on the access line of the QoS processing unit 109 is referred and the Equation 1 is used. When it is judged that the congestion has occurred (step S409: YES), the process is moved to step S412. When it is judged that no congestion has occurred (step S409: NO), a location registration request message concerning a corresponding entry is created to be transmitted to the mobile station MN as an availability notice (step S410). Then, this entry is invalidated (step S411) and the process is moved to step S412.

At step S412, it is judged whether this entry is the final entry of the BC table 104. When this entry is the final entry (step S412: YES), the above process is ended. When this entry is not the final entry (step S412: NO), a check on the next entry is executed (step S413). More specifically, this check corresponds to re-execution of the processes at step S402 and the succeeding steps.

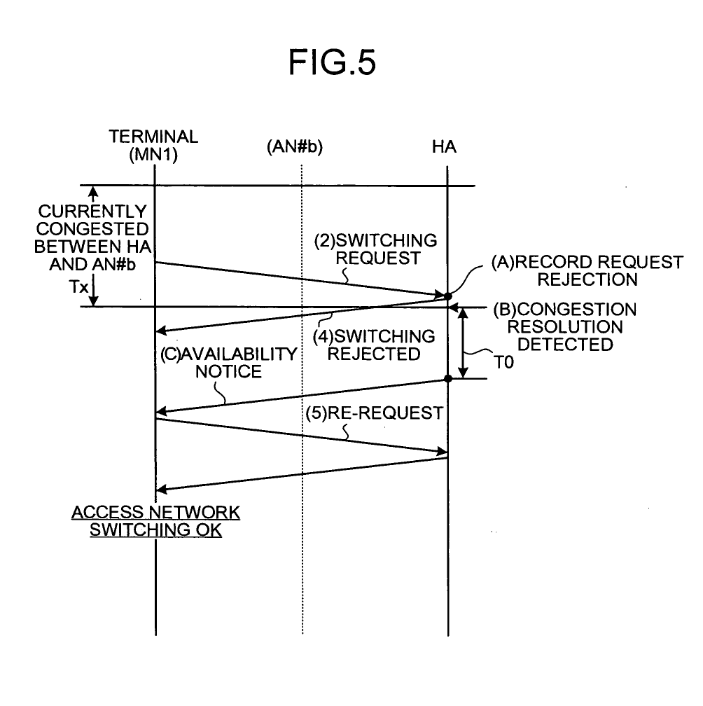

FIG. 5 is a sequence diagram for illustrating a flow of the location management control according to the first embodiment. It is assumed that congestion occurs between HA 100 and AN#b (see, FIG. 9A) for the term Tx. During this congestion term Tx, (2) when a switching request is sent from the mobile station MN1, (4) a switching rejection is notified to MN1. At this time, HA 100 (A) records the rejection of the request (step S206 of FIG. 2). Thereafter, (B) when resolution of the congestion is detected (step S409: NO of FIG. 4), HA 100 searches a corresponding entry in the BC table 104, and after a check cycle T0 (for example, 100 milliseconds) of the BC table 104 has passed, (C) sends to the mobile station MN1 the availability notice. Thus, the mobile station MN1 (5) promptly transmits a re-request (re-request of the switching) and the switching to the access network AN#b can be executed smoothly.

According to the first embodiment, as shown in FIG. 5, HA 100 sends to the mobile station MN1 the availability notice upon detecting the resolution of the congestion, and the mobile station MN1 is given an opportunity for requesting the connection. Compared to the conventional case (FIG. 9B), (5) the timing to transmit the re-request from the mobile station MN1 can be made earlier than after T1 of FIG. 9B (in the above case where the cycle T0=100 milliseconds, the waiting time is shortened to approximately 1/10 compared to the conventional case). In the above configuration, the availability notice transmitted from HA 100 to the mobile station MN1 can be made using the message (the location registration request message at step S410 of FIG. 4) of the location management protocol generally used in the existing location management systems. Therefore, no new protocol is necessary to be provided or added. Because no wasteful messages are exchanged with the mobile station MN1, resource consumption of the wireless access network is not increased.

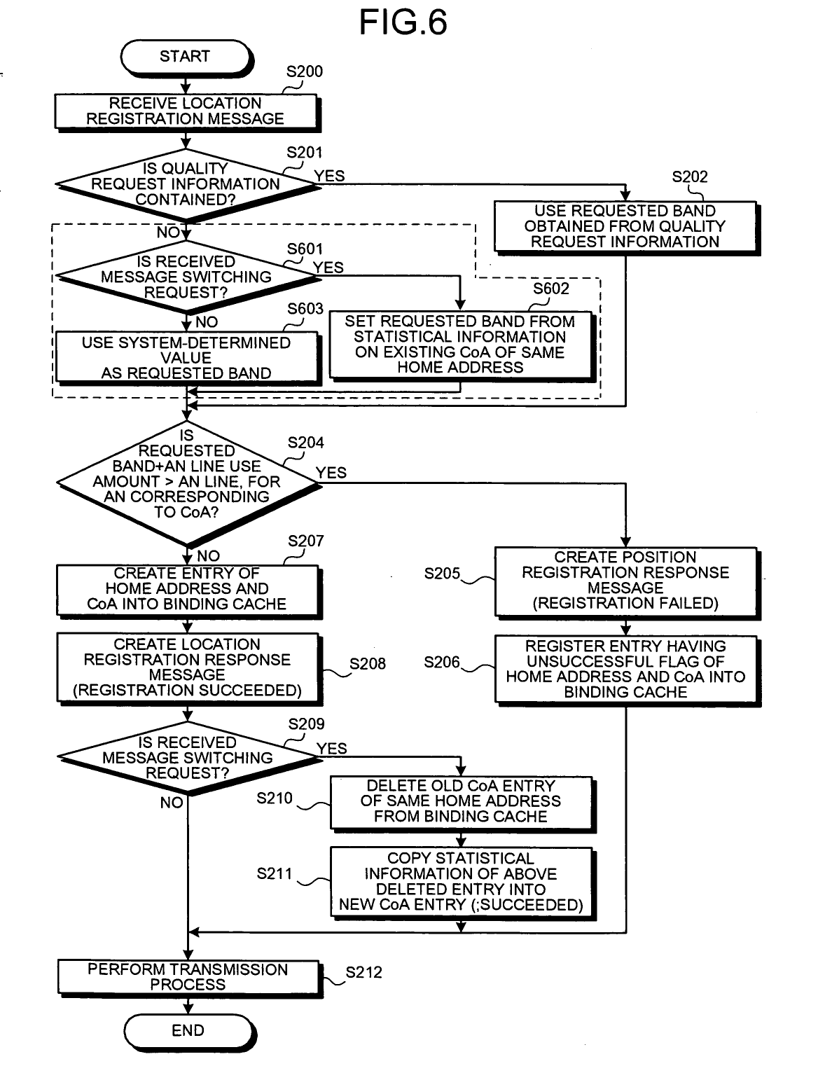

FIG. 6 is a flowchart of the location registration process by a location managing apparatus (e.g. HA) according to a second embodiment of the present invention. The second embodiment employs the configuration of the first embodiment described above as a precondition (see FIG. 9A for the entire system). A part of the process (step S203) of the flowchart (see FIG. 2) of the location registration process described in the first embodiment is modified.

When it is judged that the quality request information is not contained (step S201: NO), as the succeeding process, as shown in FIG. 6, it is judged whether the received message is a switching request (step S601). When the message is a switching request (step S601: YES), a requested bandwidth is set from the statistical information 302 (see FIG. 3) on the existing CoA of the same home address from the BC table 104 (step S602), the process is moved to step S204. When the message is not a switching request (step S601: NO), a predetermined system-determined value determined by the system is used for the requested bandwidth (step S603) and the process is moved to step S204.

It is assumed that the mobile station MN1 shown in FIG. 9A is using another access network AN#a that is connected to the same HA, and requests connection to the access network AN#b. When the mobile station MN1, based on the judgment conditions thereof, requests to switch access networks for communication to the access network AN#b, information on the amount of the communication through the access network AN#a is used to check the resource availability of the access network AN#b based on information on a use amount of communication paths of the access network AN#b.

When the communication quality can be maintained even after switching the communication path to the access network AN#b, HA 100 permits the switching, and notifies the permission to the mobile station MN1. When the communication quality may be degraded after the switching, HA 100 rejects the switching to the access network AN#b and this rejection request is recorded. When it becomes possible to accommodate an amount corresponding to the amount of the communication through the access network AN#a in the communication path of the access network AN#b, HA 100 notifies the mobile station MN1 that has once been rejected the request for switching, that the communication path of the access network AN#b is available.

As described above, according to the second embodiment, when the quality request information is not contained in the location registration message, the congestion state is judged based on the information on the use amount monitored statistically up to that time point. When the mobile station MN1 desires a bandwidth equivalent to the access network AN that has been used by the mobile station MN1, even after the switching is achieved, the quality request information (for example, QoS declaration) from the mobile station MN1 can be made unnecessary. That is, when the communication quality (e.g. bandwidth) that the mobile station MN1 desires is not changed, the QoS declaration, etc., from the mobile station is not required, thereby reducing time necessary for the switching

In a third embodiment of the present invention, an external agent, which is a foreign agent (FA), of the mobile station MN1 is disposed in the access network AN, thereby, monitoring the congestion state of the communication path of the access network AN. FA rejects a request from the mobile station MN1 for connection to the access network when congestion has occurred. When the congestion state of the communication path of the access network AN has been resolved, FA notifies the mobile station MN1 that the communication path is available, using the recorded information of request rejection.

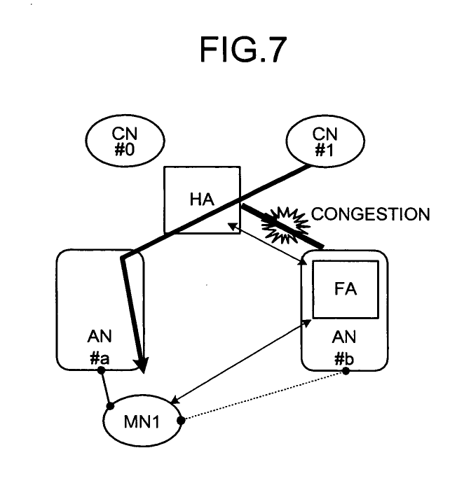

FIG. 7 is a schematic of a location managing apparatus according to the third embodiment. As shown in FIG. 7, FA is provided in the access network AN#b. FA is used based on mobile Movile IPv4, etc. and, instead of the mobile station MN1, executes a transferring process, especially encapsulating and decapsulating processes. As described above, even when FA is disposed in the access network AN, processes described in the first and the second embodiments can be executed. Though FA is described as disposed in the access network AN, FA can be handled as a part of the functions of the location managing apparatus (HA).

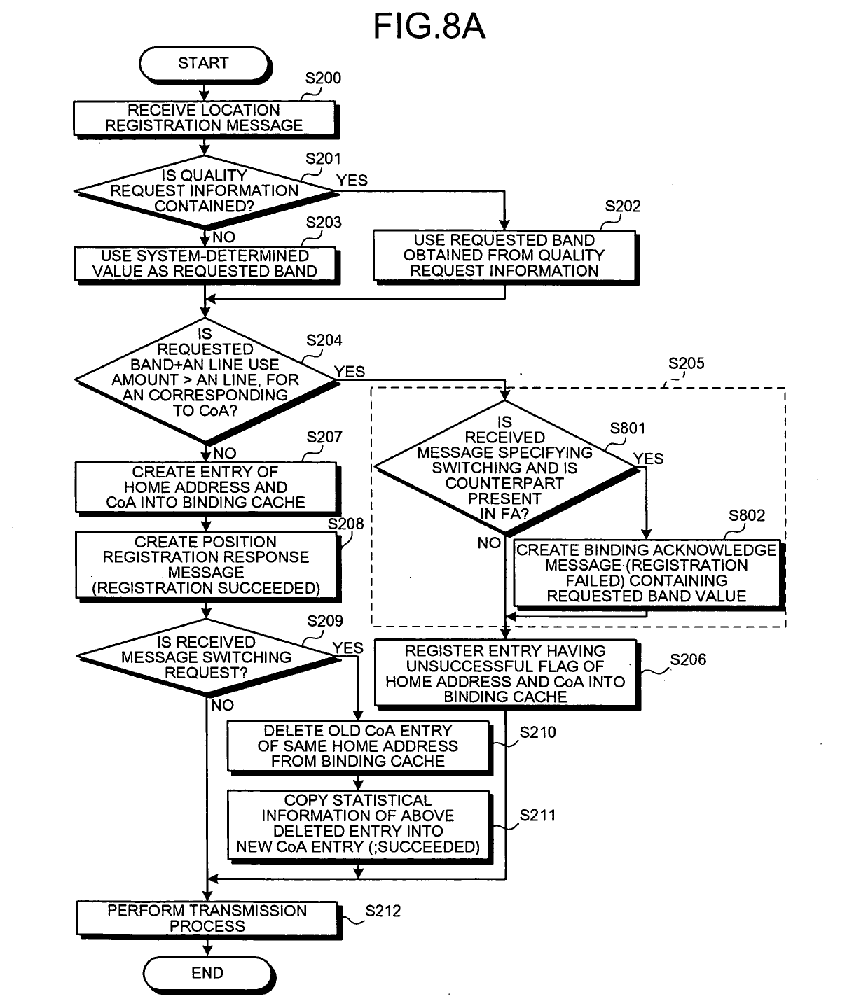

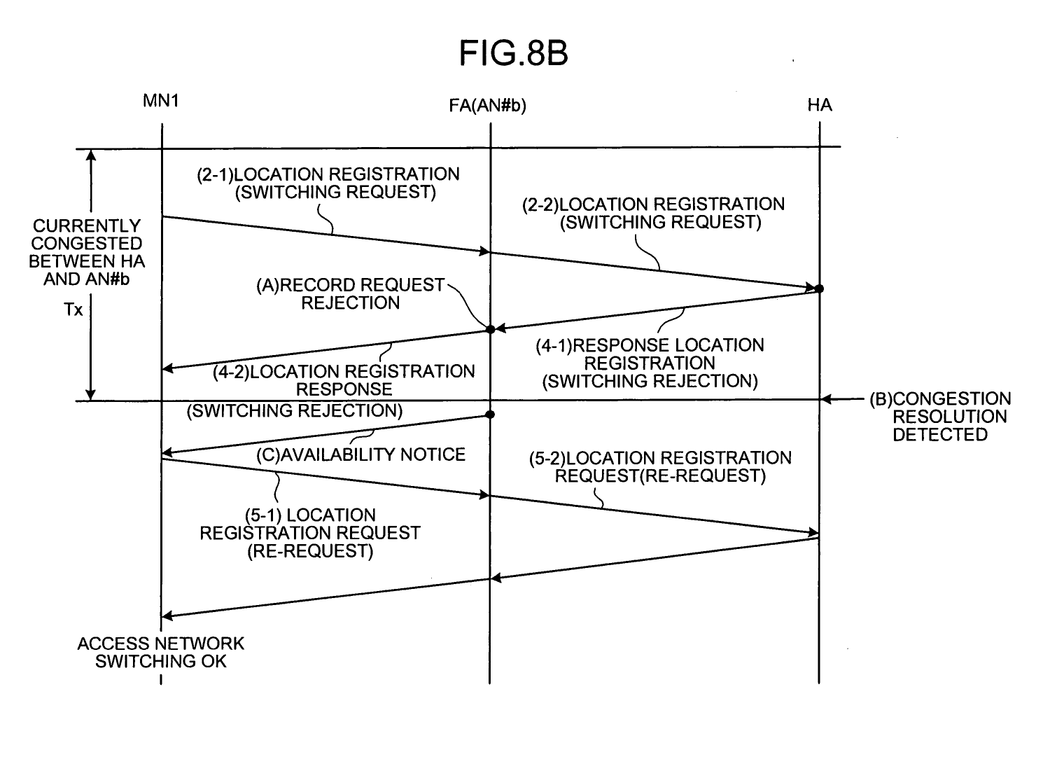

FIG. 8A is a flowchart of the location registration process by the location managing apparatus according to the third embodiment. In the third embodiment of the present invention, the configuration of the first embodiment described above is also employed as a precondition (see FIG. 9A for the entire system). A part of the process (step S205) of the flowchart (see FIG. 2) of the location registration process described in the first embodiment is modified.

When it is judged that the congestion has occurred (step S204: YES), as the succeeding process, as shown in FIG. 8A, it is judged whether the received message is a switching request and FA is present in the counterpart (switching destination) (step S801). When it is judged that the received message is a switching request and FA is present in the switching target AN (step S801: YES), a binding acknowledge message (failure of registration) containing the requested bandwidth value is created (step S802), and the process is moved to the process of step S206 (see FIG. 2), and the created message is transmitted to the mobile station MN1 at step S212. When it is judged that the received message is not a switching request, or that FA is not present in switching target AN (step S801: NO), no process for switching is executed and the process is moved to the processes at step S206 and the succeeding steps thereof.

FIG. 8B is a sequence diagram illustrating a flow of the location management control according to the third embodiment. It is assumed that congestion occurs between HA 100 and AN#b (see, FIG. 7) for the term Tx. During this congestion term Tx, (2-1) when a location registration (switching request) is sent from the mobile station MN1, FA in the access network AN#b (2-2) transmits the location registration (switching request) to HA. HA rejects acceptance of the registration because congestion has occurred between HA and the access network AN#b, and (4-1) responds using a location registration response (rejection of switching). At this time, HA is aware of the presence of FA in AN#b, and when no information on the requested quality is present and the corresponding mobile station MN#1 is currently communicating through the access network AN#a, HA responds using the location registration response (4-1) incorporating therein the quality information obtained from the statistical information 302 (see FIG. 3).

In this case, FA extracts the quality information from the location registration response, and (A) records the rejection log of the request together with the quality information. FA sends (4-2) location registration response (switching rejection) that has been formed by removing the quality information from the location registration response of (4-1), to the mobile station MN1.

Then, (B) when the resolution of the congestion has been detected, FA searches for the above rejecting log similar to an entry in the BC table 104 of HA and notifies the mobile station MN1 of (C) availability. Thereby, the mobile station MN1 immediately transmits (5-1) a location registration request (re-request), and FA transmits (5-2) the location registration request (re-request) to HA and the switching to the access network AN#b can be smoothly executed.

As described above, according to the third embodiment, the location management (switching control) similar to that of the first embodiment and the second embodiment can be applied even in a configuration in which the external agent (FA), which performs an encapsulating process and a decapsulating process instead of the mobile station, is disposed, as in mobile Mobile IPv4. FA can transfer the message (2-2) and HA can notify the traffic amount (e.g. data rate) of the existing communication using the message (4-1). In this manner, according to the third embodiment, the retention of the unsuccessful entry and the management control of the availability notice, etc., that HA executes in the first and the second embodiments can be executed by the external agent. Therefore, expansion of the location management system is easily done.

In the embodiments described above, the case where Mobile IP is used as the location management protocol has been explained. However, the location registration and the location registration request procedures are equally applicable to all other location management systems.

According to the embodiments described above, it is possible to reduce a time necessary for switching networks without increasing resource consumption of a wireless network.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus that performs location management for a mobile station connected thereto through a plurality of networks, and that determines whether to permit or reject a request for connection to a desired network made by the mobile station, the apparatus comprising:
a storing unit configured to store information on rejection of the request for the connection when congestion has occurred on a communication path of the desired network;
a searching unit configured to search in the storing unit, when the congestion is resolved, to retrieve a mobile station of which the request has been rejected; and
a notifying unit configured to notify retrieved mobile station that the desired network is available.

2. The apparatus according to claim 1, further comprising a quality determining unit configured to determine, when the mobile station requests switching of networks to the desired network based on judgment conditions of the mobile station itself, whether a current communication quality is possible to be maintained even after the switching, based on information on an amount of communication before and after the switching.

3. The apparatus according to claim 2, wherein when the quality determining unit determines that the communication quality is to be degraded after the switching, the quality determining unit is configured to notify the mobile station of rejection of the switching, and to store information on the rejection of the switching in the storing unit, and
when the quality determining unit determines that the communication quality is to be maintained even after the switching, the quality determining unit is configured to search for a mobile station of which a request for switching has been rejected in the storing unit, to notify that the desired network is available.

4. The apparatus according to claim 1, wherein
the storing unit is configured to store information on the rejection of the connection as a new entry in a form of a table, at each occurrence of the rejection of the connection, and
the searching unit is configured to periodically search the table to check a state of the communication path, and to determine whether the rejection of the connection has been resolved.

5. The apparatus according to claim 1, wherein
an external agent that performs a transferring process between the apparatus and a correspondent node in place of the mobile station is arranged in the network, the external agent monitoring congestion of a communication path of the network, and
when the congestion is present, the external agent rejects a request for connection to the network, and when the congestion is resolved, the external agent notifies the mobile station of which the request for the connection has been rejected that the network is available.

6. The apparatus according to claim 1, wherein notification of availability of the desired network is achieved using a message of a location management protocol.

7. The apparatus according to claim 6, wherein
the location management protocol includes a Mobile IP protocol, and
the apparatus performs the location management using the Mobile IP protocol.

8. A method of performing location management for a mobile station connected through a plurality of networks, the location management in which whether to permit or reject a request for connection to a desired network made by the mobile station is determined, the method comprising:
storing information on rejection of the request for the connection when congestion has occurred on a communication path of the desired network;
retrieving, when the congestion is resolved, a mobile station of which the request has been rejected, from the information; and
notifying retrieved mobile station that the desired network is available.
